(19) United States
(12) Patent Application Publication
(10) Pub. No.: US 2026/0308735 A1
(43) Pub. Date: Oct. 8, 2026

(54) AUSTENITIC STAINLESS STEEL PLATE

(71) Applicant: NIPPON STEEL STAINLESS STEEL CORPORATION, Tokyo (JP)

(72) Inventors: Mitsuki MATSUMOTO, Tokyo (JP); Masaharu HATANO, Tokyo (JP); Yoichi YAMAMOTO, Tokyo (JP); Junpei INUTSUKA, Tokyo (JP)

(73) Assignee: NIPPON STEEL STAINLESS STEEL CORPORATION, Tokyo (JP)

(21) Appl. No.: 19/108,314

(22) PCT Filed: Sep. 12, 2023
(86) PCT No.: PCT/JP2023/033133

§ 371 Date: Mar. 3, 2025

(30) Foreign Application Priority Data
Sep. 26, 2022 (JP) 2022-153097

(51) Int. Cl. C22C 38/58; C22C 38/00; C22C 38/02; C22C 38/04; C22C 38/06; C22C 38/42; C22C 38/44; C22C 38/46; C22C 38/48; C22C 38/50; C22C 38/52; C22C 38/54

(52) U.S. Cl. CPC C22C 38/58; C22C 38/001; C22C 38/002; C22C 38/005; C22C 38/02; C22C 38/04; C22C 38/06; C22C 38/42; C22C 38/44; C22C 38/46; C22C 38/48; C22C 38/50; C22C 38/52; C22C 38/54

(57) ABSTRACT

Provided is an austenitic stainless steel plate having a chemical composition consisting of, by mass %, C: 0.150% or less, Si: 2.0% or less, Mn: 3.00% or less, P: 0.060% or less, S: 0.0080% or less, Cr: 16.0 to 22.0%, Mo: 3.00% or less, Ni: 8.0 to 15.0%, Cu: 2.0% or less, Al: 0.080% or less, N: 0.250% or less, optional elements, and the balance: Fe and impurities, wherein, the maximum value of A-value [=Cr+2Si+5Mo+10Al] as measured by GDS from the outermost surface down to a depth position of 20 nm is 45 or more, the minimum value of B-value [=Cr+Ni+Mn+Cu+8N] from the outermost surface down to a depth position of 50 nm is 25 or more, and the plate thickness is 4.5 mm or more.

### TECHNICAL FIELD

The present invention relates to an austenitic stainless steel plate.

### BACKGROUND ART

In recent years, hydrogen gas is drawing attention as a new energy source that replaces fossil fuels. The hydrogen gas is a clean energy source that does not emit CO₂. On the other hand, for example, the hydrogen gas may cause hydrogen embrittlement that embrittles a material. Patent Document 1 then discloses an austenitic stainless steel with improved hydrogen gas embrittlement resistance.

### LIST OF PRIOR ART DOCUMENTS

### Patent Document

Patent Document 1: JP2015-196842A

In the meantime, for putting hydrogen gas into practical use as an energy source, it is necessary to store a large amount of liquid hydrogen compressed at a cryogenic temperature. To this end, construction of a large storage tank that can contain the liquid hydrogen (hereinafter, described simply as “liquid hydrogen container”) is projected. Here, a thick plate of austenitic stainless steel, which is a material excellent in hydrogen gas embrittlement resistance, is preferable for the application of liquid hydrogen container.

Meanwhile, such an austenitic stainless steel plate is required not only to have hydrogen gas embrittlement resistance but also to be less prone to fracture as being architectural structures. For example, it is required to suppress fracture even in the wake of an earthquake or the like. In particular, at a cryogenic temperature enough to store liquid hydrogen, it is considered that the occurrence and propagation of fracture is likely to be encouraged due to minute hydrogen gas penetrating into the steel. Accordingly, there is a demand for impact resistance capable of suppressing fracture under such a severe environment.

However, for the austenitic stainless steel disclosed in Patent Document 1, the impact resistance as described above has not been studied. Accordingly, further improvement on the impact resistance can be sought.

### SUMMARY OF INVENTION

### Technical Problem

An objective of the present invention is to solve the above-described problem and to provide an austenitic stainless steel plate with excellent impact resistance capable of suppressing fracture even when being exposed to an environment in which hydrogen gas is likely to penetrate into the steel at a cryogenic temperature enough to preserve liquid hydrogen.

### Solution to Problem

The gist of the present invention, which has been made to solve the above-described problem, is an austenitic stainless steel plate as described below.
(1) An austenitic stainless steel plate having a chemical composition consisting of, by mass %,
C: 0.150% or less,
Si: 2.0% or less,
Mn: 3.00% or less,
P: 0.060% or less,
S: 0.0080% or less,
Cr: 16.0 to 22.0%,
Mo: 3.00% or less,
Ni: 8.0 to 15.0%,
Cu: 2.0% or less,
Al: 0.080% or less,
N: 0.250% or less,
Nb: 0 to 0.10%,
Ti: 0 to 0.10%,
B: 0 to 0.0050%,
V: 0 to 0.50%,
W: 0 to 0.50%,
Ca: 0 to 0.0100%,
Mg: 0 to 0.0100%,
Zr: 0 to 0.50%,
Co: 0 to 1.0%,
Ga: 0 to 0.010%,
Hf: 0 to 0.10%,
REM: 0 to 0.10%, and
the balance: Fe and impurities, wherein
when changes in concentrations of elements O, Fe, Cr, Mn, Ni, Mo, Cu, Si, Al, and N are measured from an outermost surface of the steel plate in a depth direction by using glow discharge optical emission spectrometry and a total amount of the elements except for O is converted to 100% by mass %,
a maximum value of A-value calculated by Formula (i) described below is 45 or more in a region from the outermost surface down to a depth position of 20 nm,
a minimum value of B-value calculated by Formula (ii) described below is 25 or more in a region from the outermost surface down to a depth position of 50 nm, and
the austenitic stainless steel plate has a plate thickness of 4.5 mm or more:

$$A - value = Cr + 2 Si + 5 Mo + 10 Al \qquad ( i )$$

$$B - value = Cr + Ni + Mn + Cu + 8 N \qquad ( ii )$$

where each element symbol in the Formulas (i) and (ii) represents a content (by mass %) of each element measured in each depth position in the glow discharge optical emission spectrometry and is zero when the element is not contained.
(2) The austenitic stainless steel plate according to the above (1), wherein the chemical composition contains one or more elements selected from, by mass %,
Nb: 0.01 to 0.10%,
Ti: 0.01 to 0.10%,
B: 0.0002 to 0.0050%,
V: 0.05 to 0.50%,
W: 0.05 to 0.50%,
Ca: 0.0002 to 0.0100%,
Mg: 0.0002 to 0.0100%,
Zr: 0.01 to 0.50%,
Co: 0.01 to 1.0%,
Ga: 0.001 to 0.010%,
Hf: 0.01 to 0.10%, and
REM: 0.01 to 0.10%.
(3) The austenitic stainless steel plate according to the above (1) or (2), wherein in the chemical composition, M-value calculated by Formula (iii) described below further satisfies −100 or less:

$$M - value = 551 - 462 ( C + N ) - 9.2 Si - 8.1 Mn - 13.7 Cr - 29 ( Ni + Cu ) - 18.2 Mo \qquad ( iii )$$

where each element symbol in the Formula (iii) represents a content (by mass %) of each element contained in the steel and is zero when the element is not contained.

### Advantageous Effects of Invention

According to the present invention, it is possible to obtain an austenitic stainless steel plate with excellent impact resistance capable of suppressing fracture even when being exposed to an environment in which hydrogen gas is likely to penetrate into the steel at a cryogenic temperature enough to preserve liquid hydrogen.

### DESCRIPTION OF EMBODIMENTS

The inventors have studied impact resistance under an environment in which liquid hydrogen is stored and obtained the following findings.
(a) A large liquid hydrogen container is an architectural structure that has a capacity as large as several ten thousand m³. Accordingly, it is necessary to use a material that does not cause fracture even in the wake of an earthquake or the like. In particular, it is considered that at a cryogenic temperature enough to preserve liquid hydrogen, specifically at −235° C. or less, even slight penetration of hydrogen into the steel from the environment leads to hydrogen embrittlement and fracture is likely to occur.
(b) The penetration of hydrogen into the steel from the environment is more likely to occur as the temperature is higher. However, during a long-term use, hydrogen penetrates into the steel to cause hydrogen embrittlement even at a cryogenic temperature. From the viewpoint of improving hydrogen embrittlement resistance, it is desirable to use an austenitic stainless steel plate capable of suppressing hydrogen from penetrating into the steel for liquid hydrogen containers.
(c) As a result of study conducted by the inventors on a method for suppressing hydrogen from penetrating into the steel, it has been found that forming a passivation film mainly made of Cr₂O₃ on a steel plate surface is effective to suppress penetration of hydrogen. Furthermore, dissolving Si, Mo, and Al into the passivation film is effective. It is considered that these elements improve denseness of the passivation film, so that penetration of hydrogen is suppressed.
(d) In addition, the inventors have obtained findings indicating that controlling the chemical composition of Cr, Ni, Mn, Cu, and N near the surface of the base metal suppresses a decrease in toughness. The elements Cr, Ni, Mn, Cu, and N, which stabilize austenite, are reduced near the surface during annealing due to being used for forming oxide scale or the like. It is considered that the region with reduced elements described above is embrittled due to hydrogen penetrating slightly therein and acts as a starting point of fracture.

An embodiment of the present invention has been made based on the above-described findings. The requirements of the embodiment will now be described in detail.

### 1. Chemical Composition

The reason for limitation for each element is described below. Note that in the description below, “%” for a content refers to “by mass %”.

### C: 0.150% or Less

C (carbon) is an element that is effective for stabilization of the austenite phase and also contributes to improvement of hydrogen gas embrittlement resistance. However, excessively contained C promotes grain boundary precipitation of Cr carbide and is likely to form a starting point of fracture. As a result, the impact resistance degrades. Accordingly, the content of C is 0.150% or less. The content of C is preferably 0.100% or less and is preferably 0.050% or less. On the other hand, to obtain the above-described effects, the content of C is preferably 0.010% or more.

### Si: 2.0% or Less

Si (silicon) is an element that is effective for deoxidation and also contributes to improvement of hydrogen gas embrittlement resistance. However, excessively contained Si promotes generation of an intermetallic compound such as a o phase and is likely to form a starting point of fracture. As a result, the impact resistance degrades. Accordingly, the content of Si is 2.0% or less. The content of Si is preferably 1.5% or less and more preferably 1.0% or less. On the other hand, to obtain the above-described effects, the content of Si is preferably 0.30% or more.

### Mn: 3.00% or Less

Mn (manganese) is an element that is effective for stabilization of the austenite phase and contributes to improvement of hydrogen gas embrittlement resistance. However, excessively contained Mn promotes generation of an F phase that is highly sensitive to hydrogen embrittlement, which leads to degradation of hydrogen gas embrittlement resistance. Furthermore, MnS excessively precipitates, and the impact resistance degrades. Accordingly, the content of Mn is 3.00% or less. The content of Mn is preferably 2.00% or less and more preferably 1.00% or less. On the other hand, to obtain the above-described effects, the content of Mn is preferably 0.30% or more.

### P: 0.060% or Less

P (phosphorus) is an element contained in the steel as an impunity and an element that is likely to segregate at grain boundaries. Accordingly, P is an element that may form a starting point of fracture, leading to degradation of impact resistance. Accordingly, the content of P is 0.060% or less. The content of P is preferably 0.050% or less and more preferably 0.040% or less. On the other hand, since excessively reducing P leads to an increase in production costs, the content of P is preferably 0.010% or more.

### S: 0.0080% or Less

S (sulfur) is an element contained in the steel as an impunity and is an element that forms MnS and may form a starting point of fracture, so that the impact resistance degrades. Accordingly, the content of S is 0.0080% or less. The content of S is preferably 0.0050% or less and more preferably 0.0030% or less. However, excessively reducing the content of S leads to an increase in production costs. Accordingly, the content of S is preferably 0.0003% or more.

### Cr: 16.0 to 22.0%

Cr (chromium) is an element that is contained in stainless steel at a certain amount and produces an effect of improving corrosion resistance. Accordingly, the content of Cr is 16.0% or more. However, Cr is a ferrite-forming element. Accordingly, excessively contained Cr makes the austenite phase unstable, leading to degradation of hydrogen gas embrittlement resistance. Cr also causes degradation of impact resistance. Accordingly, the content of Cr is 22.0% or less. The content of Cr is preferably 21.0% or less and more preferably 20.0% or less.

### Mo: 3.00% or Less

Mo (molybdenum) produces an effect of improving strength. However, excessively contained Mo promotes generation of a 6 ferrite phase, which leads to degradation of hydrogen gas embrittlement resistance. Accordingly, the content of Mo is 3.00% or less. The content of Mo is preferably 2.50% or less and more preferably 2.20% or less. On the other hand, excessively reducing the content of Mo leads to constraints in molten raw materials, and production costs increase. Accordingly, the content of Mo is preferably 0.05% or more.

### Ni: 8.0 to 15.0%

Ni (nickel) is an element necessary to secure hydrogen gas embrittlement resistance and impact resistance, along with Mn. Accordingly, the content of Ni is 8.0% or more. However, excessively contained Ni increases production costs. In addition, segregation is likely to occur. Accordingly, the content of Ni is 15.0% or less. The content of Ni is preferably 14.0% or less, more preferably 13.0% or less, and further preferably 12.5% or less.

### Cu: 2.0% or Less

Cu (copper) is an element introduced from raw materials such as scrap and is an element that is effective for stabilization of the austenite phase. On the other hand, Cu is a low melting point element and segregates at grain boundaries, so that a starting point of fracture is likely to occur. Accordingly, the content of Cu is 2.0% or less. The content of Cu is preferably 1.0% or less and more preferably 0.70% or less. However, excessively reducing the content of Cu leads to constraints in molten raw materials, and production costs increase. Accordingly, the content of Cu is preferably 0.05% or more.

### Al: 0.080% or Less

Al (aluminum), which is an effective deoxidation element, suppresses grain boundary segregation of low melting point elements, producing an effect of enhancing grain boundaries. As a result, Al also produces an effect of improving impact resistance. However, since Al is a ferrite-forming element, excessively contained Al makes austenite phase unstable, leading to degradation of hydrogen gas embrittlement resistance. Accordingly, the content of Al is 0.080% or less. The content of Al is preferably 0.050% or less. On the other hand, to obtain the above-described effects, the content of Al is preferably 0.005% or more and more preferably 0.010% or more.

### N: 0.250% or Less

N (nitrogen) is an element that is effective for improving hydrogen gas embrittlement resistance similarly to Mn and Ni. However, excessively contained N may cause inner defects such as blowholes while being melted to occur, so that a starting point of fracture is likely to occur. As a result, the impact resistance degrades. Accordingly, the content of N is 0.250% or less. The content of N is preferably 0.200% or less and more preferably 0.100% or less. On the other hand, to obtain the above-described effects, the content of N is preferably 0.010% or more.

In addition to the above-described elements, one or more elements selected from Nb, Ti, B, V, W, Ca, Mg, Zr, Co, Ga, Hf, and REM may further be contained to the extent indicated below. The reason for limitation for each element will be described.

### Nb: 0 to 0.10%

Nb (niobium) forms carbonitride and refines grains, producing an effect of enhancing grain boundaries. As a result, Nb produces an effect of improving impact resistance. Accordingly, Nb may be contained as necessary. However, excessively contained Nb causes degradation of producibility during hot rolling and workability. Furthermore, a large number of inclusions are formed and the impact resistance may degrade. Accordingly, the content of Nb is 0.10% or less. The content of Nb is preferably 0.07% or less. On the other hand, to obtain the above-described effects, the content of Nb is preferably 0.01% or more.

### Ti: 0 to 0.10%

Ti (titanium) forms carbonitride and refines grains, producing an effect of enhancing grain boundaries. As a result, the impact resistance is improved. Accordingly, Ti may be contained as necessary. However, excessively contained Ti causes degradation of producibility during hot rolling. Furthermore, a large number of inclusions are formed and the impact resistance may degrade. Accordingly, the content of Ti is 0.10% or less. The content of Ti is preferably 0.070% or less, preferably 0.050% or less, and further preferably 0.020% or less. On the other hand, to obtain the above-described effects, the content of Ti is preferably 0.001% or more.

### B: 0 to 0.0050%

B (boron) enhances grain boundaries, improves strength, and produces an effect of improving impact resistance. Accordingly, B may be contained as necessary. However, excessively contained B only causes the effect to be saturated, and what is worse, the impact resistance may degrade. Accordingly, the content of B is 0.0050% or less. The content of B is preferably 0.0030% or less. On the other hand, to obtain the above-described effects, the content of B is preferably 0.0002% or more.

### V: 0 to 0.50%

V (vanadium) precipitates in the steel as a solid solution or carbonitride and produces an effect of improving strength. Accordingly, V may be contained as necessary. However, excessively contained V causes excessive formation of carbonitride, leading to degradation of producibility during hot rolling. Furthermore, the impact resistance may degrade. Accordingly, the content of V is preferably 0.50% or less. The content of V is preferably 0.30% or less. On the other hand, to obtain the above-described effects, the content of V is preferably 0.05% or more.

### W: 0 to 0.50%

W (tungsten) produces an effect of improving strength and corrosion resistance.

Accordingly, W may be contained as necessary. However, excessively contained W increases production costs. Accordingly, the content of W is 0.50% or less. The content of W is preferably 0.30% or less. On the other hand, to obtain the above-described effects, the content of W is preferably 0.05% or more.

### Ca: 0 to 0.0100%

Ca (calcium) suppresses grain boundary segregation of low melting point elements, producing an effect of enhancing grain boundaries. As a result, the impact resistance improves. Accordingly, Ca may be contained as necessary. However, excessively contained Ca is likely to cause segregation, which is likely to be a starting point of fracture. As a result, the impact resistance may degrade. Accordingly, the content of Ca is 0.0100% or less. The content of Ca is preferably 0.0050% or less. On the other hand, to obtain the above-described effects, the content of Ca is preferably 0.0002% or more.

### Mg: 0 to 0.0100%

Mg (magnesium) suppresses grain boundary segregation of low melting point elements, producing an effect of enhancing grain boundaries. As a result, the impact resistance improves. Accordingly, Mg may be contained as necessary. However, excessively contained Mg causes formation of a large number of inclusions, which is likely to be a starting point of fracture, and as a result, the impact resistance may degrade. Accordingly, the content of Mg is 0.0100% or less. The content of Mg is preferably 0.0050% or less. On the other hand, to obtain the above-described effects, the content of Mg is preferably 0.0002% or more.

### Zr: 0 to 0.50%

Zr (zirconium) produces a deoxidation effect. Furthermore, Zr produces an effect of improving corrosion resistance. Accordingly, Zr may be contained as necessary. However, excessively contained Zr causes degradation of toughness and workability. Furthermore, a large number of inclusions are formed, which is likely to be a starting point of fracture, and as a result, the impact resistance may degrade. Accordingly, the content of Zr is 0.50% or less. The content of Zr is preferably 0.30% or less. On the other hand, to obtain the above-described effects, the content of Zr is preferably 0.010% or more.

### Co: 0 to 1.0%

Co (cobalt) produces an effect of improving impact resistance. Furthermore, Co improves corrosion resistance and produces an effect of stabilizing the austenite phase. Accordingly, Co may be contained as necessary. However, excessively contained Co causes degradation of toughness and workability. Accordingly, the content of Co is 1.0% or less. The content of Co is preferably 0.70% or less. On the other hand, to obtain the above-described effects, the content of Co is preferably 0.01% or more, more preferably 0.05% or more, and further preferably 0.10% or more.

### Ga: 0 to 0.010%

Ga (gallium) produces an effect of improving hot workability. Accordingly, Ga may be contained as necessary. However, excessively contained Ga causes degradation of producibility. Accordingly, the content of Ga is 0.010% or less. The content of Ga is preferably 0.009% or less. On the other hand, to obtain the above-described effects, the content of Ga is preferably 0.001% or more.

### Hf: 0 to 0.10%

Hf (hafnium) improves strength and produces an effect of improving hydrogen embrittlement resistance. Accordingly, Hf may be contained as necessary. However, excessively contained Hf causes degradation of workability. Accordingly, the content of Hf is 0.10% or less. The content of Hf is preferably 0.07% or less. On the other hand, to obtain the above-described effects, the content of Hf is preferably 0.01% or more.

### REM: 0 to 0.10%

REM produces an effect of improving hot workability. Furthermore, REM produces an effect of improving corrosion resistance. Accordingly, REM may be contained as necessary. However, excessively contained REM not only causes the effect to be saturated, but also causes degradation of hot workability. Accordingly, the content of REM is 0.10% or less. The content of REM is preferably 0.07% or less. On the other hand, to obtain the above-described effects, the content of REM is preferably 0.01% or more.

REM refers to a total of 17 elements of Sc, Y, and lanthanoid, and the content of REM refers to a total content of the elements. Industrially, REM is often contained as misch metal.

In the chemical composition of the embodiment, the balance is Fe and impurities. Here, “impunities” refer to components that are introduced due to various factors in raw materials such as scrap and ore and production processes when the austenitic stainless steel plate is industrially produced and that are acceptable to the extent that they do not adversely affect the embodiment.

### M-Value

M-value calculated by Formula (iii) described below is an indicator that indicates the stability of a γ phase in the austenitic stainless steel plate. In the austenitic stainless steel plate of the embodiment, M-value is preferably −100 or less for more improved impact resistance:

$$M - value = 551 - 462 ( C + N ) - 9.2 Si - 8.1 Mn - 13.7 Cr - 29 ( Ni + Cu ) - 18.2 Mo \qquad ( iii )$$

where each element symbol in the Formula (iii) represents a content (by mass %) of each element contained in the steel and is zero when the element is not contained.

By keeping M-value −100 or less, it is possible to secure the stability of a γ phase, while suppressing transformation into an α′ phase, so that the impact resistance can be further improved. M-value is more preferably −110 or less and further preferably −120 or less.

Although there is no need to establish a lower limit, when M-value is less than −220, a large number of elements have to be added, so that alloy costs increase. Accordingly, M-value is preferably −220 or more, more preferably −210 or more, and further preferably −200 or more.

### 2. Chemical Composition in Surface Layer Region

As described above, to suppress hydrogen from penetrating into the steel, it is important to form a passivation film mainly made of Cr₂O₃ and including Si, Mo, and Al dissolved therein. In addition, it is possible to suppress a decrease in toughness by controlling the chemical composition of Cr, Ni, Mn, Cu, and N near the surface of the base metal. That is, it is important to control the chemical composition in a surface layer region of the steel plate to improve impact resistance under an environment in which liquid hydrogen is stored.

In the embodiment, the chemical composition in the surface layer region of the steel plate is measured by glow discharge optical emission spectrometry (GDS). Specifically, GDS is used to measure changes in concentrations of elements O, Fe, Cr, Mn, Ni, Mo, Cu, Si, Al, and N from an outermost surface of the steel plate in a depth direction, and a total amount of the elements except for O is converted to 100% by mass %.

From the viewpoint as described above, in the embodiment, the maximum value of A-value calculated by Formula (i) is 45 or more in a region from the outermost surface of the steel plate down to a depth position of 20 nm, and the minimum value of B-value calculated by Formula (ii) is 25 or more in a region from the outermost surface of the steel plate down to a depth position of 50 nm.

### A-Value

A-value is a value serving as an indicator of the ability of the passivation film to suppress hydrogen penetration. In the austenitic stainless steel plate of the embodiment, to improve impact resistance, the maximum value of A-value calculated in each depth position in a region from an outermost surface of the steel plate down to a depth position of 20 nm is 45 or more:

$$A - value = Cr + 2 Si + 5 Mo + 10 Al \qquad ( i )$$

where each element symbol in the Formula (i) represents a content (by mass %) of each element measured in each depth position in the glow discharge optical emission spectrometry and is zero when the element is not contained.

A passivation film is a thin film of less than 20 nm, and typically made mainly of oxide of Fe and Cr depending on the chemical composition of the base metal. As a result of studies conducted by the inventors, it has been found that, by optimizing production conditions, the proportion of Cr oxide can be improved and Si, Mo, and Al can be dissolved in the passivation film.

When the maximum value of A-value is less than 45, the proportion of Fe oxide is excessive, and therefore, an effect of suppressing hydrogen penetration into the steel cannot be produced sufficiently. The maximum value of A-value is preferably 50 or more and more preferably 55 or more. There is no need to establish an upper limit because the higher the maximum value of A-value, the more preferable it is. However, 80 is a substantial upper limit in terms of production feasibility.

### B-Value

B-value is a value serving as an indicator of toughness of the base metal. In the austenitic stainless steel plate of the embodiment, from the viewpoint of suppressing a decrease in toughness in the surface of the base metal, the minimum value of B-value calculated in each depth position in a region from the outermost surface of the steel plate down to a depth position of 50 nm is 25 or more:

$$B - value = Cr + Ni + Mn + Cu + 8 N \qquad ( ii )$$

where each element symbol in the Formula (ii) represents a content (by mass %) of each element measured in each depth position in the glow discharge optical emission spectrometry and is zero when the element is not contained.

Cr, Ni, Mn, Cu, and N are elements that stabilize austenite. When these elements are reduced near the surface of the base metal, toughness decreases accordingly, leading to embrittlement due to hydrogen slightly penetrating therein, so that a starting point of fracture occurs. As a result of studies conducted by the inventors, it has been found that a decrease in B-value can be suppressed by controlling annealing conditions, in particular.

When the minimum value of B-value is less than 25, a decrease in toughness becomes significant, which makes it difficult to secure impact resistance under an environment in which liquid hydrogen is stored. The minimum value of B-value is preferably 27 or more and more preferably 29 or more. There is no need to establish an upper limit because the higher the minimum value of B-value, the more preferable it is. However, 44 is a substantial upper limit in connection with the chemical composition of the base metal.

The analysis by GDS is performed on one arbitrary point selected from a region in which the number of surface defects is small. At the measurement point, each element concentration of elements O, Fe, Cr, Mn, Ni, Mo, Cu, Si, Al, and N is measured at a pitch of 0.8 to 1.2 nm from the outermost surface of the steel plate down to a depth position of 50 nm while sputtering is being performed. In this way, the contents (by mass %) of the elements are determined at each depth position. At this time, the total amount of the elements except for O is converted to 100% by mass %. For each depth position, A-value and B-value described above are calculated, and the maximum value of A-value and the minimum value of B-value are determined from all the calculated measurements.

As a measurement device of GDS, for example, a device called GD-Profiler 2 from HORIBA, Ltd. can be used with measurement conditions: 35W, argon pressure: 600 Pa, frequency: 100 Hz, and measurement diameter: 4 mmΦ.

### 3. Plate Thickness

The plate thickness of the austenitic stainless steel plate of the embodiment is 4.5 mm or more. The plate thickness is in the range described above because the strength required for liquid hydrogen containers can be assured. The plate thickness is preferably 10 mm or more and more preferably 20 mm or more. For use in a larger liquid hydrogen container, the plate thickness is preferably 30 mm or more. Here, although not particularly limited, the upper limit of the plate thickness is typically 100 mm.

### 4. Application

The austenitic stainless steel plate of the embodiment is excellent in hydrogen gas embrittlement resistance and impact resistance at a cryogenic temperature, and therefore, it is preferably used for liquid hydrogen containers. In particular, preferable applications are large on-land liquid hydrogen containers that have 10,000 m³ or more or 50,000 m³ or more in capacity.

### 5. Production Method

A preferable production method for the austenitic stainless steel plate of the embodiment will be described. For example, the austenitic stainless steel plate of the embodiment can stably be produced by production method as described below.

A cast piece such as a slab is produced by melting the stainless steel having the chemical composition described above. Next, the cast piece is heated to a predetermined temperature for hot rolling (hot rolling process). The range of heating temperature during hot rolling is 1050 to 1250° C., and the rolling reduction is preferably 40% or more. The heating temperature during hot rolling and the rolling reduction are in the range described above because a desired plate thickness is more controllable.

The hot rolling process is followed by an annealing process and a descaling process. In the annealing process, the temperature is held in the range of 1000 to 1100° C. for 1 to 30 minutes. When the heating temperature in the annealing process is less than 1000° C. or the holding time is less than 1 minute, the effect of annealing cannot be obtained sufficiently. On the other hand, when the heating temperature in the annealing process is more than 1100° C. or the holding time is more than 30 minutes, Cr, Ni, Mn, Cu, and N near the surface of the base metal are excessively used for forming oxide scale, which makes it difficult to keep the minimum value of B-value described above at 25 or more.

In the descaling process following the annealing process, scale generated by annealing is removed by pickling, in which the steel plate is immersed in nitric hydrofluoric acid solution at 40 to 80° C. for 1 to 30 minutes. In this way, the maximum value of A-value can be made 45 or more. Furthermore, prior to pickling, it is preferable to grind and remove scale generated by annealing to verify the metal surface, and thereafter further remove the base metal of the thickness of 100 m or more. The composition of a passivation film formed after descaling process is made suitable by grinding: specifically, it is possible to keep the maximum value of A-value at 55 or more.

The austenitic stainless steel plate according to the present invention will now be described with reference to examples in detail. However, the embodiment is not limited to the examples.

### Example

The stainless steel having the chemical composition indicated in Table 1 was melted, and slabs were produced. Thereafter, the slabs were heated within the range of 1050 to 1250° C. for hot rolling. After hot rolling, annealing was performed under the conditions indicated in Table 2, followed by pickling to obtain the austenitic stainless steel plates. In some examples, scale generated by annealing was ground and removed prior to pickling, the metal surfaces were verified, and thereafter, the base metals of the thickness within the range of 100 to 200 μm were further removed. The status of each process of how it was performed is as shown in Table 2.

TABLE 1

| | Chemical composition (mass %, balance: Fe and impurities) | | | | | | | | | | | | |
|---|---|---|---|---|---|---|---|---|---|---|---|---|---|
| Steel | C | Si | Mn | P | S | Cr | Mo | Ni | Cu | Al | N | Nb | Ti |
| A | 0.017 | 0.64 | 0.83 | 0.031 | 0.0010 | 17.5 | 2.08 | 12.1 | 0.25 | 0.032 | 0.035 | 0.03 | 0.002 |
| B | 0.008 | 0.41 | 0.84 | 0.025 | 0.0006 | 17.7 | 2.10 | 12.2 | 0.30 | 0.003 | 0.028 | 0.02 | 0.005 |
| C | 0.140 | 0.55 | 0.78 | 0.030 | 0.0075 | 21.5 | 0.05 | 12.2 | 0.35 | 0.021 | 0.015 | | |
| D | 0.032 | 0.60 | 0.90 | 0.030 | 0.0031 | 16.8 | 0.10 | 9.1 | 1.8 | 0.075 | 0.160 | 0.09 | 0.090 |
| E | 0.012 | 1.9 | 2.82 | 0.053 | 0.0009 | 18.6 | 0.30 | 14.3 | 0.20 | 0.009 | 0.045 | | |
| F | 0.017 | 0.55 | 0.75 | 0.029 | 0.0015 | 16.3 | 2.70 | 8.1 | 0.19 | 0.009 | 0.240 | | |
| G | 0.159 | 0.51 | 0.82 | 0.033 | 0.0033 | 17.2 | 1.50 | 12.1 | 0.13 | 0.015 | 0.033 | | |
| H | 0.019 | 0.48 | 3.12 | 0.031 | 0.0050 | 17.1 | 0.55 | 12.3 | 0.15 | 0.019 | 0.045 | | |
| I | 0.022 | 0.53 | 0.81 | 0.065 | 0.0039 | 17.3 | 0.34 | 12.2 | 0.14 | 0.021 | 0.022 | | |
| J | 0.015 | 0.52 | 0.78 | 0.019 | 0.0082 | 17.1 | 0.16 | 11.9 | 0.12 | 0.025 | 0.151 | | |
| K | 0.012 | 0.51 | 0.83 | 0.033 | 0.0033 | 22.4 | 0.33 | 12.0 | 0.33 | 0.035 | 0.020 | | |
| L | 0.032 | 0.35 | 0.80 | 0.033 | 0.0035 | 19.1 | 2.18 | 7.7 | 0.32 | 0.021 | 0.051 | | |
| M | 0.024 | 0.50 | 0.79 | 0.035 | 0.0028 | 17.5 | 0.35 | 12.1 | 0.25 | 0.038 | 0.259 | | |

| | Chemical composition (mass %, balance: Fe and impurities) | | | | | | | | | | M- |
|---|---|---|---|---|---|---|---|---|---|---|---|
| Steel | B | V | W | Ca | Mg | Zr | Co | Ga | Hf | REM | value |
| A | 0.0002 | 0.10 | | 0.0035 | 0.0011 | | 0.25 | 0.008 | | | −122 |
| B | | | | 0.0019 | | | 0.11 | | | | −119 |
| C | | | 0.43 | 0.0089 | 0.0090 | | | | | 0.09 | −191 |
| D | | | 0.10 | | | | 0.96 | | 0.08 | | −99 |
| E | 0.0044 | 0.46 | | | | 0.02 | | | 0.02 | 0.01 | −196 |
| F | | | | | | 0.45 | | | | | −92 |
| G | | | | | | | | | | | −167 |
| H | | | | | | | | | | | −114 |
| I | | | | | | | | | | | −82 |
| J | | | | | | | | | | | −123 |
| K | | | | | | | | | | | −146 |
| L | | | | | | | | | | | −31 |
| M | | | | | | | | | | | −195 |

M-value = 551-462(C + N) − 9.2Si − 8.1Mn − 13.7Cr − 29(Ni + Cu) − 18.2Mo . . . (iii)
Underline means outside the range of the chemical composition defined in the present embodiment.

TABLE 2

| | | Production condition | | | Sheet | Surface layer region | | Evaluation of characteristics | | |
|---|---|---|---|---|---|---|---|---|---|---|
| | | | Grinding | | thick- | Maximum | Minimum | Impact | Judgement | |
| Test | | Annealing condition | prior to | Pickling condition | ness | value of | value of | value | of impact | |
| No. | Steel | Tempeature × time | pickling | Tempeature × time | (mm) | A-value | B-value | (J/cm²) | characteristics | |
| 1 | A | 1100° C. × 5 min | Not performed | 50° C. × 6 min | 50 | 53 | 29 | 125 | A | Inventive |
| 2 | | 1100° C. × 5 min | Performed | 50° C. × 3 min | 50 | 63 | 31 | 131 | A | example |
| 3 | | 1100° C. × 5 min | Performed | 50° C. × 6 min | 50 | 74 | 31 | 133 | A | |
| 4 | B | 1100° C. × 5 min | Not performed | 50° C. × 6 min | 50 | 54 | 30 | 122 | A | |
| 5 | | 1100° C. × 5 min | Performed | 50° C. × 3 min | 50 | 65 | 32 | 133 | A | |
| 6 | | 1000° C. × 30 min | Performed | 50° C. × 6 min | 50 | 76 | 32 | 135 | A | |
| 7 | C | 1000° C. × 30 min | Not performed | 50° C. × 1 min | 40 | 54 | 33 | 125 | A | |
| 8 | | 1000° C. × 30 min | Performed | 80° C. × 1 min | 40 | 71 | 35 | 132 | A | |
| 9 | D | 1100° C. × 5 min | Not performed | 50° C. × 6 min | 60 | 50 | 27 | 111 | B | |
| 10 | | 1100° C. × 5 min | Performed | 40° C. × 30 min | 60 | 57 | 29 | 127 | A | |
| 11 | E | 1100° C. × 5 min | Not performed | 50° C. × 6 min | 30 | 53 | 36 | 126 | A | |
| 12 | F | 1100° C. × 5 min | Not performed | 50° C. × 6 min | 40 | 47 | 25 | 107 | B | |
| 13 | | 1100° C. × 5 min | Performed | 50° C. × 3 min | 40 | 61 | 28 | 125 | A | |
| 14 | | 1150° C. × 30 min | Not performed | 50° C. × 6 min | 40 | 44 | 22 | 85 | F | Comparative |
| 15 | | 1150° C. × 30 min | Performed* | 50° C. × 15 min | 40 | 53 | 23 | 91 | F | example |
| 16 | G | 1100° C. × 5 min | Performed | 50° C. × 6 min | 40 | 72 | 31 | 91 | F | |
| 17 | H | 1100° C. × 5 min | Not performed | 50° C. × 6 min | 40 | 54 | 32 | 87 | F | |
| 18 | I | 1100° C. × 5 min | Not performed | 50° C. × 6 min | 40 | 53 | 29 | 75 | F | |
| 19 | J | 1100° C. × 5 min | Not performed | 50° C. × 6 min | 40 | 51 | 31 | 78 | F | |
| 20 | K | 1100° C. × 5 min | Not performed | 50° C. × 6 min | 40 | 53 | 35 | 92 | F | |
| 21 | L | 1100° C. × 5 min | Not performed | 50° C. × 6 min | 40 | 54 | 28 | 95 | F | |
| 22 | M | 1100° C. × 5 min | Not performed | 50° C. × 6 min | 40 | 50 | 31 | 90 | F | |

A-value = Cr + 2Si + 5Mo + 10Al . . . (i)
B-value = Cr + Ni + Mn + Cu + 8N . . . (ii)
Underline indicates that the checmical composition falls outside the requirement of the present embodiment or the target characteristics are not satisfied.
*Grinding of Test No. 15 was stopped immediately after the metal surface is verified.

### Measurement of Chemical Composition of Surface Layer Region

For each obtained austenitic stainless steel plate, analysis by GDS was performed on one arbitrary point selected from a range in which the number of surface defects is small. At the measurement point, each element concentration of elements O, Fe, Cr, Mn, Ni, Mo, Cu, Si, Al, and N was measured at a pitch of about 1 nm from the outermost surface of the steel plate down to a depth position of 50 nm while sputtering is being performed to determine the content (by mass %) of each element at each depth position. At this time, the total amount of the elements except for O was converted to 100% by mass %. Then, for each depth position, A-value and B-value described above were calculated, and the maximum value of A-value and the minimum value of B-value were determined from all the calculated measurements.

As a measurement device of GDS, a device called GD-Profiler 2 from HORIBA, Ltd. was used with measurement conditions: 35W, argon pressure: 600 Pa, frequency: 100 Hz, and measurement diameter: 4 mmΦ.

### Evaluation of Impact Resistance

The impact resistance at a cryogenic temperature was measured in the procedure described below. Specifically, a V-notch subsize Charpy test specimen of 55 mm length×10 mm width×5 mm thickness was sampled. The direction of the Charpy test specimen was L-direction and sampled from the center portion of the plate thickness. After the obtained Charpy test specimen was placed in a pressure vessel, the atmosphere in the pressure vessel was replaced with hydrogen gas, and then heat was applied and pressure was raised, so that the test specimen was held under the environment at 10 MPa and 300° C. for 300 hours.

Thereafter, the Charpy test specimen, with a thermocouple being applied thereto, was secured to a jig and inserted in a tubular cooling capsule made of urethane. While liquid He was caused to flow into the cooling capsule, the temperature of the test specimen was measured. Once −253° C. was reached and after 10 seconds hold, a Charpy test was performed, in which the cooling capsule itself was impacted in C-direction. Adjustment was made on the absorbed energy by subtracting a portion of the cooling capsule (3.53 J). Other conditions than those described above were compliant with JIS Z 2242: 2018.

Given the results of the above-described test, when the Charpy impact value was less than 100 J/cm², the judgement of impact characteristics was described as F. When the Charpy impact value was 100 J/cm² or more and less than 120 J/cm², the judgement of impact characteristics was described as B. Furthermore, when the Charpy impact value was 120 J/cm² or more, the judgement of impact characteristics was described as A. The following summarizes obtained results, which are indicated in Table 2.

The test Nos. 1 to 13 satisfied the requirements of the embodiment, and therefore, had good impact resistance at a cryogenic temperature. In particular, the test Nos. 2, 3, 5, 6, 8, 10, and 13, which were subjected to grinding prior to pickling, exhibited 55 or more in the maximum value of A-value, resulting in improved impact values compared to the case without grinding being performed.

On the other hand, the test Nos. 14 to 22 did not satisfy the requirements of the embodiment, and therefore, the impact resistance at a cryogenic temperature was poor. Specifically in the test Nos. 14 and 15, the minimum value of B-value ended in less than defined values because of excessively high annealing temperature. In addition, in the test No. 14, which was not subjected to grinding prior to pickling, the maximum value of A-value also ended in less than a defined value. As a result, the impact resistance degraded.

In the test No. 16, because of an excessive content of C, carbide excessively precipitated, resulting in degraded impact resistance. In the test No. 17, because of an excessive content of Mn, MnS excessively precipitated, resulting in degraded impact resistance. In the test No. 18, because of an excessive content of P, grain boundary segregation occurred, resulting in degraded impact resistance. In the test No. 19, because of an excessive content of S, MnS excessively precipitated, resulting in degraded impact resistance.

In the test No. 20, because of an excessive content of Cr, hydrogen gas embrittlement resistance decreased, resulting in degraded impact resistance. In the test No. 21, the shortage of the content of Ni resulted in degraded hydrogen gas embrittlement resistance and impact resistance. In the test No. 22, because of an excessive content of N, a starting point of fracture was likely to occur, resulting in degraded impact resistance.

### INDUSTRIAL APPLICABILITY

According to the present invention, it is possible to obtain an austenitic stainless steel plate with excellent impact resistance capable of suppressing fracture even when being exposed to an environment in which hydrogen gas is likely to penetrate into the steel at a cryogenic temperature enough to preserve liquid hydrogen.

1. An austenitic stainless steel plate having a chemical composition consisting of, by mass %,
C: 0.150% or less,
Si: 2.0% or less,
Mn: 3.00% or less,
P: 0.060% or less,
S: 0.0080% or less,
Cr: 16.0 to 22.0%,
Mo: 3.00% or less,
Ni: 8.0 to 15.0%,
Cu: 2.0% or less,
Al: 0.080% or less,
N: 0.250% or less,
Nb: 0 to 0.10%,
Ti: 0 to 0.10%,
B: 0 to 0.0050%,
V: 0 to 0.50%,
W: 0 to 0.50%,
Ca: 0 to 0.0100%,
Mg: 0 to 0.0100%,
Zr: 0 to 0.50%,
Co: 0 to 1.0%,
Ga: 0 to 0.010%,
Hf: 0 to 0.10%,
REM: 0 to 0.10%, and
the balance: Fe and impurities, wherein
when changes in concentrations of elements O, Fe, Cr, Mn, Ni, Mo, Si, Cu, Al, and N are measured from an outermost surface of the steel plate in a depth direction by using glow discharge optical emission spectrometry and a total amount of the elements except for O is converted to 100% by mass %,
a maximum value of A-value calculated by Formula (i) described below is 45 or more in a region from the outermost surface down to a depth position of 20 nm,
a minimum value of B-value calculated by Formula (ii) described below is 25 or more in a region from the outermost surface down to a depth position of 50 nm, and
the austenitic stainless steel plate has a plate thickness of 4.5 mm or more:
$$A - value = Cr + 2 Si + 5 Mo + 10 Al \qquad ( i )$$
$$B - value = Cr + Ni + Mn + Cu + 8 N \qquad ( ii )$$
where each element symbol in the Formulas (i) and (ii) represents a content (by mass %) of each element measured in each depth position in the glow discharge optical emission spectrometry and is zero when the element is not contained.

2. The austenitic stainless steel plate according to claim 1, wherein the chemical composition contains one or more elements of, by mass %,
Nb: 0.01 to 0.10%,
Ti: 0.01 to 0.10%,
B: 0.0002 to 0.0050%,
V: 0.05 to 0.50%,
W: 0.05 to 0.50%,
Ca: 0.0002 to 0.0100%,
Mg: 0.0002 to 0.0100%,
Zr: 0.01 to 0.50%,
Co: 0.01 to 1.0%,
Ga: 0.001 to 0.010%,
Hf: 0.01 to 0.10%, and
REM: 0.01 to 0.10%.

3. The austenitic stainless steel plate according to claim 1, wherein in the chemical composition, M-value calculated by Formula (iii) described below further satisfies −100 or less:
$$M - value = 551 - 462 ( C + N ) - 9.2 Si - 8.1 Mn - 13.7 Cr - 29 ( Ni + Cu ) - 18.2 Mo \qquad ( iii )$$
where each element symbol in the Formula (iii) represents a content (by mass %) of each element contained in the steel and is zero when the element is not contained.

4. The austenitic stainless steel plate according to claim 2, wherein in the chemical composition, M-value calculated by Formula (iii) described below further satisfies −100 or less:
$$M - value = 551 - 462 ( C + N ) - 9.2 Si - 8.1 Mn - 13.7 Cr - 29 ( Ni + Cu ) - 18.2 Mo \qquad ( iii )$$
where each element symbol in the Formula (iii) represents a content (by mass %) of each element contained in the steel and is zero when the element is not contained.

5. An austenitic stainless steel plate having a chemical composition comprising, by mass %,
C: 0.150% or less,
Si: 2.0% or less,
Mn: 3.00% or less,
P: 0.060% or less,
S: 0.0080% or less,
Cr: 16.0 to 22.0%,
Mo: 3.00% or less,
Ni: 8.0 to 15.0%,
Cu: 2.0% or less,
Al: 0.080% or less,
N: 0.250% or less,
Nb: 0 to 0.10%,
Ti: 0 to 0.10%,
B: 0 to 0.0050%,
V: 0 to 0.50%,
W: 0 to 0.50%,
Ca: 0 to 0.0100%,
Mg: 0 to 0.0100%,
Zr: 0 to 0.50%,
Co: 0 to 1.0%,
Ga: 0 to 0.010%,
Hf: 0 to 0.10%,
REM: 0 to 0.10%, and
the balance: Fe and impurities, wherein
when changes in concentrations of elements O, Fe, Cr, Mn, Ni, Mo, Si, Cu, Al, and N are measured from an outermost surface of the steel plate in a depth direction by using glow discharge optical emission spectrometry and a total amount of the elements except for O is converted to 100% by mass %,
a maximum value of A-value calculated by Formula (i) described below is 45 or more in a region from the outermost surface down to a depth position of 20 nm,
a minimum value of B-value calculated by Formula (ii) described below is 25 or more in a region from the outermost surface down to a depth position of 50 nm, and
the austenitic stainless steel plate has a plate thickness of 4.5 mm or more:
$$A - value = Cr + 2 Si + 5 Mo + 10 Al \qquad ( i )$$
$$B - value = Cr + Ni + Mn + Cu + 8 N \qquad ( ii )$$
where each element symbol in the Formulas (i) and (ii) represents a content (by mass %) of each element measured in each depth position in the glow discharge optical emission spectrometry and is zero when the element is not contained.
